(19) United States
(12) Patent Application Publication
(10) Pub. No.: US 2006/0026644 A1
(43) Pub. Date: Feb. 2, 2006

(54) Receiving device and receiving method

(76) Inventor: Toru Yamagishi, Yokohama-shi (JP)

Correspondence Address: NATH & ASSOCIATES, 1030 15th STREET, NW, 6TH FLOOR, WASHINGTON, DC, 20005, US

(21) Appl. No.: 11/190,997

(22) Filed: Jul. 28, 2005

(30) Foreign Application Priority Data
Jul. 30, 2004 (JP) P2004-224392
Mar. 18, 2005 (JP) P2005-079302
May 13, 2005 (JP) P2005-141835

(51) Int. Cl. H04N 7/16; H04H 9/00; H04N 5/445; H04N 7/173; G06F 13/00

(52) U.S. Cl. 725/46; 725/100; 725/9; 725/14; 725/134; 725/142

(57) ABSTRACT

Station selection history information is stored in a flash memory for each predetermined time (for example, 5 minutes) in the past from a predetermined number of days ago to the current time. In response to a station selection instruction, a CPU calculates a corrected time by rounding the current time to a time at which the station selection history information is to be stored next. If the station selection history information on a past (for example, a day ago, a week ago) at a time corresponding to the corrected time is stored in the flash memory, the CPU selects a broadcast station included in the stored station selection history information.

### BACKGROUND OF THE INVENTION

1. Field of the Invention

The present invention relates to a receiving device and a receiving method for receiving a broadcast via radio waves or the Internet.

The present invention is applicable to a receiving device for receiving broadcasting waves, a receiving device for receiving an Internet broadcast, and various apparatuses in which those receiving devices are built for example, DVD recorder, hard disk recorder, home server, television set, STB, personal computer, and cellular phone, etc.

2. Description of the Related Art

Conventionally, a device for storing the history of programs, which were watched in the past, in the memory is proposed to allow the user to tune in to a broadcast station (channel) of a program watched, for example, a day ago or a week ago (For example, see Japanese Patent Laid-Open Publication No. Hei 6(1994)-70245, Japanese Patent Laid-Open Publication No. Hei 6(1994)-311443).

A device is also proposed that allows the user to check a program name on the Electronic Program Guide (EPG) and set up a recorder to record a program on a daily, weekly, or Monday-to-Friday basis (for example, see Japanese Patent Laid-Open Publication No. 2003-46921).

However, the station selection methods described in Japanese Patent Laid-Open Publication No. Hei 6-70245 and Japanese Patent Laid-Open Publication No. Hei 6-311443 have a problem that, when a desired program is not broadcast because the program broadcast schedule is changed due to the broadcast of a special program, the user cannot tune in to the broadcast station (channel) of the desired program correctly.

In addition, if the user tunes in to the broadcast station of a desired program after the start time of the desired program and if the user wants to watch the same program also in the next week, the user tunes in to the broadcast station of the desired program next week at least at the same tune-in time or at a later time. For example, the station selection method described in Japanese Patent Laid-Open Publication No. Hei 6-311443 given above is as follows. If the start time of a desired program is 11:00 but the user tuned in to the broadcast station of the program at 11:16 last week, the user can tune in to the broadcast station of the desired program next week at least 11:16 or at a later time. Therefore, the user cannot watch the program from the start and the method is not easy to use.

In addition, to precisely tune in to the broadcast station of a program watched a day ago or a week ago, history information such as the one described in Japanese Patent Laid-Open Publication No. Hei 6-311443 described above must be recorded in a cycle as short as possible (for example, at one-minute interval). This requires a large memory area for saving the history information. Furthermore, the technologies described in the three documents given above are not fully compatible with a function to auto-tune reliably in to the station of a program, watched a day ago or a week ago, before the start of program broadcasting.

### SUMMARY OF THE INVENTION

In view of the foregoing, it is an object of the present invention to provide a receiving device and a receiving method for auto-tuning reliably to the station of a program, watched in the past, before the start of program broadcasting.

To achieve the above objects, according to one aspect of the present invention, there is provided a receiving device comprising: receiving means for receiving a broadcast; operation means for performing a station selection instruction operation; storage means for sequentially storing station selection history information including at least a selected broadcast station for each unit time; and control means for, when station selection history information in a past at a time corresponding to a corrected time is stored in the storage means, selecting a broadcast station included in the stored station selection history information, the corrected time being generated by rounding a current time to a next multiple of the unit time.

The “past” means a time that is a predetermined period before today, such as “a week ago” or “a day ago”, or a fixed period in the past such as a period within a week, within two weeks, or within a month from today. “The corrected time generated by rounding a current time to a next multiple of the unit time” is that, if the unit time is “5 minutes” and the current time is “14:56”, the corrected time is a time generated by rounding the current time of “14:56” to the next multiple of the unit time of “5 minutes”, that is “15:00”.

Therefore, if the station selection history information in the past at a time corresponding to the time generated by rounding the current time to the next multiple of the unit time (for example, 5 minutes, 10 minutes, and so on) is stored in the storage means, the user auto-tunes into the broadcast station of the program. Thus, even if the current time is before the broadcast start time of a desired program (for example, 0-5 minutes before the start of program broadcasting or 0-10 minutes before the start of program broadcasting, and so on), the user can auto-tune into the broadcast station of the desired program.

In addition, because the station selection history information stored in the storage means need not be stored in a short cycle, for example, at intervals of one minute, but may be stored in a relatively long cycle (unit time) as the user wishes, for example, at intervals of 5 minutes, 10 minutes, 15 minutes, and so on according to the user's watching condition, the amount of the storage means can be saved.

In a preferred embodiment of the present invention, the receiving device further comprises acquisition means for acquiring an Electronic Program Guide that includes broadcast stations, program start/end dates and times, and program names of programs that are broadcast, wherein, if the station selection history information in a past at a time corresponding to a corrected time is stored in the storage means, the control means further checks if program information, composed of the same broadcast station and the same program name as a broadcast station and a program name stored in the station selection history information, is included in the Electronic Program Guide as program information at the corrected time of today and, if such program information is included, selects the broadcast station stored in the stored station selection history information.

The receiving device checks whether program information, composed of the same broadcast station and the same program name as a broadcast station and a program name stored in the station selection history information in a past at a time corresponding to the corrected time, is included in the Electronic Program Guide as program information at the corrected time of today and, if such program information is included, selects the broadcast station stored in the stored station selection history information. Therefore, in addition to the above-described effect, if a desired program is suspended, for example, a program watched in the past at a corrected time generated by rounding the current time to the next multiple of the unit time, is suspended, because the program broadcast schedule is changed due to the broadcast of a special program, the broadcast station is not automatically selected to prevent incorrect station selection.

To achieve the above objects, according to another aspect of the present invention, there is provided a receiving station comprising: receiving means for receiving a broadcast; acquisition means for acquiring an Electronic Program Guide that includes broadcast stations, program start/end dates and times, and program names of programs that are broadcast; operation means for performing a station selection instruction operation; storage means for sequentially storing watching history information including at least a selected broadcast station, a program name, a watching start date and time, and a watching time for each unit time; and control means that acquires program information on all broadcast stations broadcast at a time corresponding to a corrected time, generated by rounding a current time to a next multiple of the unit time, from the Electronic Program Guide and at the same time extracts programs, watched for a time equal to or longer than a predetermined watching time, from station selection history information in a past stored in the storage means, compares the program information on all broadcast stations broadcast at the time corresponding to the corrected time with the programs watched for a time equal to or longer than the predetermined watching time, and, if there is one matching program, selects a broadcast station of the matching program and, if there are a plurality of matching programs, selects a broadcast station of one program from the plurality of matching programs.

Even if the user watches programs while zapping the channels to switch among a plurality of channels in a short time and the history information is changed every unit time, the receiving device eliminates programs that are watched for a time shorter than a predetermined time (for example, zapping), thus preventing the user from tuning in to an unintended program.

In a preferred embodiment of the present invention, if there are the plurality of matching programs as a result of the comparison between the program information on all broadcast stations broadcast at a time corresponding to the corrected time and the programs watched for a time equal or longer than the predetermined watching time, the control means selects a broadcast station of a program watched first after the current time from the plurality of matching programs.

In another preferred embodiment of the present invention, if there are the plurality of matching programs as a result of the comparison between the program information on all broadcast stations broadcast at a time corresponding to the corrected time and the programs watched for a time equal or longer than the predetermined watching time, the control means selects a broadcast station of a program started first from the plurality of matching programs.

In still another preferred embodiment of the present invention, if there are the plurality of matching programs as a result of the comparison between the program information on all broadcast stations broadcast at a time corresponding to the corrected time and the programs watched for a time equal or longer than the predetermined watching time, the control means selects a broadcast station of a program watched for a longest time from the plurality of matching programs.

To achieve the above objects, according to still another aspect of the present invention, there is provided a receiving method comprising the steps of: sequentially storing station selection history information including at least a selected broadcast station for each unit time; calculating a corrected time in response to an automatic station selection instruction from a user, the corrected time being generated by rounding a current time to a next multiple of the unit time; and checking if the station selection history information in a past at a time corresponding to the corrected time is stored and, if such information is stored, selecting a broadcast station included in the stored station selection history information.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing an example of the configuration of a receiving device in a first embodiment of the present invention;

FIG. 2 is a general diagram showing an example of the external view of a remote controller;

FIG. 3 is an image diagram showing an example of a screen display when automatic station selection is instructed via GUI;

FIG. 4 is a flowchart showing an example of an algorithm (first embodiment) for registering station selection history information in a flash memory;

FIG. 5 is a schematic diagram showing an example of the memory configuration in the flash memory of the receiving device shown in FIG. 1;

FIG. 6 is a flowchart showing an example of an algorithm (first embodiment) for auto-tuning in to the channel of a program, which is the same program watched yesterday, before the broadcast of the program is started;

FIG. 7 is a flowchart showing an example of an algorithm (second embodiment) for auto-tuning in to the channel of a program, which is the same program watched yesterday, before the broadcast of the program is started;

FIG. 8 is a flowchart showing an example of an algorithm (third embodiment) for registering watching history information in the flash memory;

FIG. 9 is a flowchart showing an example of an algorithm (third embodiment) for auto-tuning in to the channel of a program, which is the same program watched yesterday, before the broadcast of the program is started;

FIG. 10 is a diagram showing an example of watching history in the third embodiment; and

FIG. 11 is a flowchart showing an example of an algorithm (fourth embodiment) for auto-tuning in to the channel of a program, which is the same program watched yesterday, before the broadcast of the program is started.

### DESCRIPTION OF THE PREFERRED EMBODIMENTS

Embodiments of the present invention will be described below in detail with reference to the drawings. In all of the drawings, the same reference numeral is given to components having the same or equivalent function and repetitive description will be omitted or simplified.

### First Embodiment

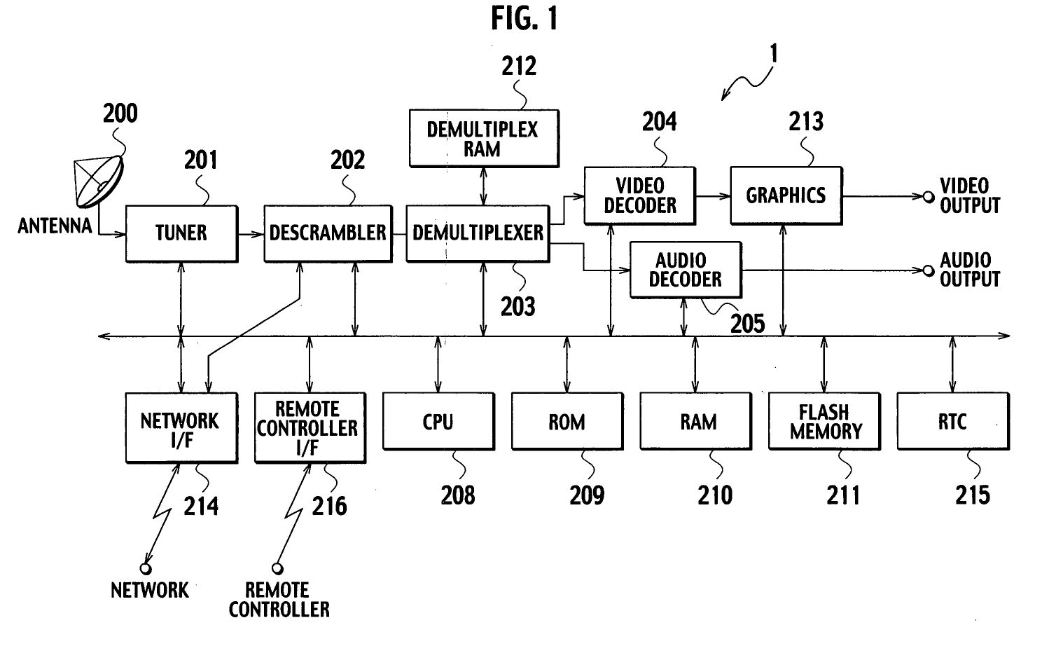

FIG. 1 shows an example of the configuration of a receiving device in this embodiment. First, when a broadcast is received via a radio wave, a tuner 201 selects a channel from the radio wave entering at an antenna 200. Unlike an analog broadcast, a digital broadcast allows multiple broadcasting operators to broadcast programs using one channel.

Therefore, the tuner 201 selects a channel based on a frequency and, at the same time, selects one broadcasting operator from the multiple broadcasting operators in the selected frequency channel.

On the other hand, when an Internet broadcast is received, the broadcast is received via a network I/F 214 using one of various protocols. Although a CPU 208 and a network I/F 214 control the protocol, the present invention does not put any limit on the protocol type and the control method.

Next, either data of the radio broadcast or the Internet broadcast passes through a descrambler 202. For example, for a pay-broadcast for which a charge must be paid, the broadcast signal is scrambled in advance to prevent it from being watched free of charge. The descrambler 202 is a circuit for descrambling the broadcast signal so that the user can view the broadcast only when a specific authentication card is inserted into the receiving device and the payment of the charge is confirmed. A free broadcast that is scrambled must also be descrambled for viewing.

The signal passing through the descrambler 202 passes through a demultiplexer 203. The demultiplexer 203 demultiplexes the signal into video data and audio data and stores them temporarily in a demultiplex RAM 212. After that, from the demultiplex RAM 212, the video data is sent to a video decoder 204, and the audio data to an audio decoder 205.

The video decoder 204 decodes the compressed video data. After that, the data of a graphics 213 of the GUI (Graphical User Interface) is superimposed on the decoded video data, which is then output onto a monitor as a video output.

The audio decoder 205 decodes the compressed audio data for output to an audio amplifier as an audio output.

The components described above, that is, the tuner 201 to the audio decoder 205, are connected to the CPU 208 via the bus and operate under control of the CPU 208. In addition to the components described above, a ROM 209 in which programs executed in the CPU 208 are stored, a RAM 210 in which variables used in the CPU 208 are stored, a flash memory 211, the network I/F 214, an RTC (Real Time Clock) 215, and a remote controller I/F 216 are connected to the bus of the CPU 208.

In addition to the audio data and the video data described above, the demultiplexer 203 extracts SI/PSI information and data carousel information and temporarily stores them in the demultiplex RAM 212. The CPU 208 reads them, converts the SI information into information for the EPG (Electronic Program Guide) or extracts BML document information from the data carousel information, and stores them in the RAM 210. PSI (Program Specific Information), composed primarily of PAT and PMT defined by MPEG-2, describes what information, audio or video, is included in its TS (Transport Stream). SI (Service Information), which refers to digital data describing the delivery system, contents, and schedule/timing of a service information broadcast data stream, as well as its unique extension part, is defined by MPEG-2. Sometimes SI and PSI information are called together as PSI/SI information. An XML-based language, provided only for tags and attributes used in a multimedia representation defined according to the ARIB STD-B24 standard that is the data broadcast standard for a domestic digital broadcast, is called BML (Broadcast Markup Language), and a document coded in BML is called a BML document.

In response to an instruction for displaying the EPG information from the user via the remote controller I/F 216, the CPU 208 presents the user with the EPG information via the graphics 213. The EPG information on today and several subsequent days can be obtained. A BML document is executed automatically or through a user operation, and the GUI part included in a BML document is presented to the user via the graphics 213.

The RTC 215 is a clock that either contains a quartz oscillator for generating time information or manages time based on time data received from a broadcast as the SI information. In the latter case, the CPU 208 obtains TOT (Time Offset Table: current date, current time, and summer time information are included), which is time information included in the SI information, from the demultiplex RAM 212 via the demultiplexer 203 and stores the obtained information in the RTC 215. The time managed by the RTC 215 may be an absolute time in the form yy/mm/dd/hh/mm/ss or sometimes a relative time indicating the number of clock oscillations of the quartz oscillator after the receiving device was turned on. In either case, the CPU 208 can obtain its time data from the RTC 215.

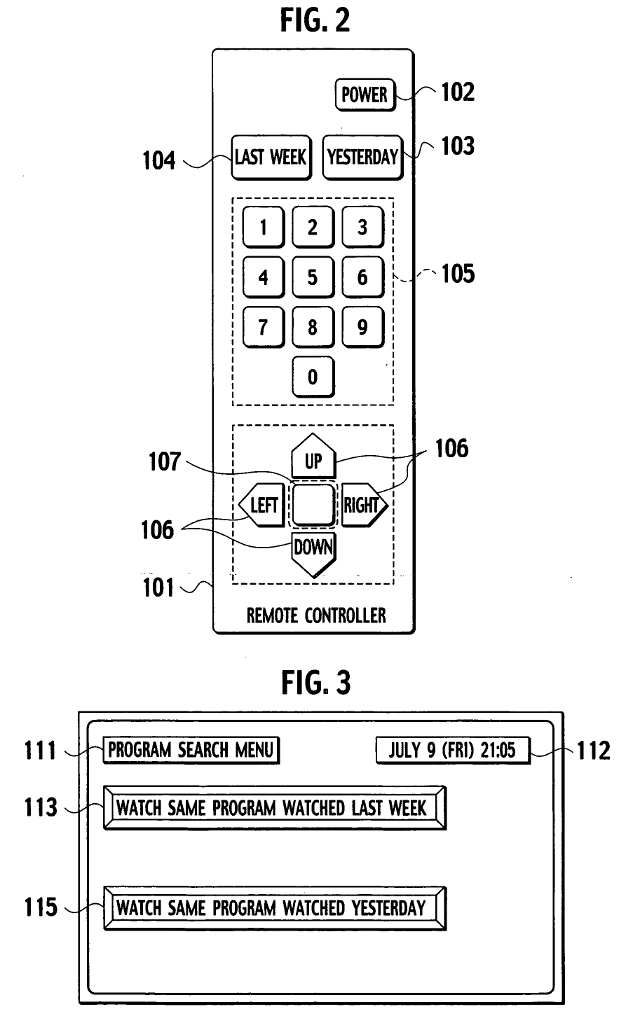

The remote controller I/F 216 receives a command via an infrared ray sent from a remote controller 101 shown in FIG. 2 and stores the obtained command therein. The CPU 208 can read a command from the remote controller I/F 216 to detect which button of the remote controller 101 was pressed or released.

The EPG (Electronic Program Guide), which provides information on programs described above such as broadcast stations (channel), program start/end times and dates, and program names, can be obtained either from the SI information (more specifically, descriptors such as EIT) included in the radio waves or by downloading information from a site on the Internet that provides similar information. Note that the EIT (Event Information Table) is a table containing program information such as program names, broadcast dates and times, durations, and broadcast contents.

The flash memory 211 is a nonvolatile memory whose contents are not lost even when the power is turned off. The flash memory 211 stores station selection history information including information on broadcast stations (channels), program start/end dates and times, and program names of programs that were watched in the past.

FIG. 2 is an external general view of the remote controller 101. The remote controller 101 has a Power button 102, a Yesterday key 103, a Last Week key 104, a ten-key pad 105, cross keys 106, and a Confirmation key 107. When the Yesterday key 103 is pressed on this remote controller 101, the receiver automatically tunes in to the broadcast station (channel) of the program watched at this time of yesterday (a day ago). When the Last Week key 104 is pressed, the receiver automatically tunes in to the broadcast station (channel) of the program watched at this time of last week (a week ago).

FIG. 3 shows an example of how to auto-tune to a station selection via GUI. In this case, the user uses the cross keys 106 and the Confirmation key 107 on the remote controller 101 for the operation. That is, when the GUI screen shown in FIG. 3 is displayed, the focus is on a Last Week button 113 and, at this time, the color of the Last Week button 113 is changed to green to indicate that the focus is on.

When the “Down key” of the cross keys 106 on the remote controller 101 is pressed in this state, the focus moves to a Yesterday button 115. When the “Up key” of the cross keys 106 is pressed again, the focus moves to the Last Week button 113. When the Confirmation key 107 is pressed with the focus on the Last Week button 113, the receiver tunes in to the broadcast station of the program watched last week. Similarly, when the Confirmation key 107 is pressed with the focus on the Yesterday button 115, the receiver tunes in to the broadcast station of the program watched yesterday. In this case, the remote controller 101 may or may not have the Yesterday key 103 and the Last Week key 104 shown in FIG. 2

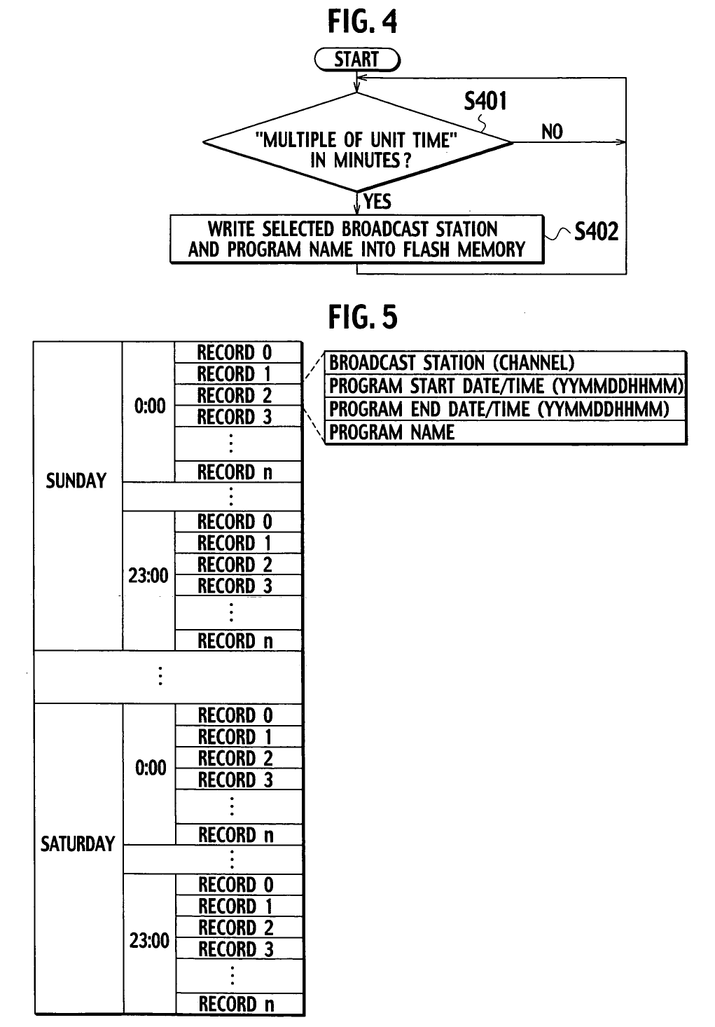

FIG. 4 shows an example of the processing procedure for registering the information on a program, which is being watched, into the flash memory 211 as station selection history information. FIG. 5 shows an example of the configuration of memory in the flash memory 211 where the station selection history information is stored.

As shown in FIG. 4, the processing starts when the receiving device starts receiving a broadcast. The CPU 208 monitors if the current time (in minutes) stored in the RTC 215 is “a multiple of unit times” (step S401). For example, if the unit time is “5 minutes”, then “a multiple of unit times” in minutes is 0 minute (60 minutes), 5 minutes, 10 minutes, 15 minutes, . . . , 50 minutes, and 55 minutes; if the unit time is “10 minutes”, then “a multiple of unit times” in minutes is 0 minute (60 minutes), 10 minutes, 20 minutes, . . . , 50 minutes.

The CPU 208 repeats the checking processing in step S401 until the current time (in minutes) becomes “a multiple of unit times” in minutes and, when the current time becomes “a multiple of unit times”, writes the currently selected broadcast station (channel), the program start/end date and time, and program name into the flash memory 211 as the station selection history information (step S402). The station selection history information written in this case is configured of information for each unit time as shown in FIG. 5, and this information is called a record.

To record the programs of last week, one week of information must be recorded. If the unit time is “5 minutes” in the description below, then the number of records that must be recorded in a week equals 7[days]×24[hours]×60[minutes]/5[minutes]=2,016[records]. The length of a record may be fixed or variable. Because the data on a broadcast station and a program start/end date and time is fixed-length data, the record length of a variable-length record depends on the length of a program name. For a variable-length record, the information on the length of a program name is added to the start of the program name to indicate the record length.

For simplicity, assume that the record is a fixed-length record in the description below. If the length of a record is N bytes, the storage position of a record is determined by the day of week, hour, and minute. That is, if the record storage position at 00:00 on Sunday is A, the record at 17:55 on Thursday is stored at the recording position S calculated by expression (1) because Thursday is 4 days after Sunday.
S=A+(4×24×60+17×60+55)/5×N=A+1367N (1)

To generalize expression (1), the recording position S of a record at m minutes after h hours on a day of week that is d days after Sunday is calculated by expression (2) where the unit time is p.
S=A+(d×24×60+h×60+m)/p×N (2)

After writing the record into the flash memory in step S402, control is passed back to step S401. The CPU 208 repeats the processing operation described above until the reception of the broadcast is ended.

Initially, all records indicate that no broadcast station is selected.

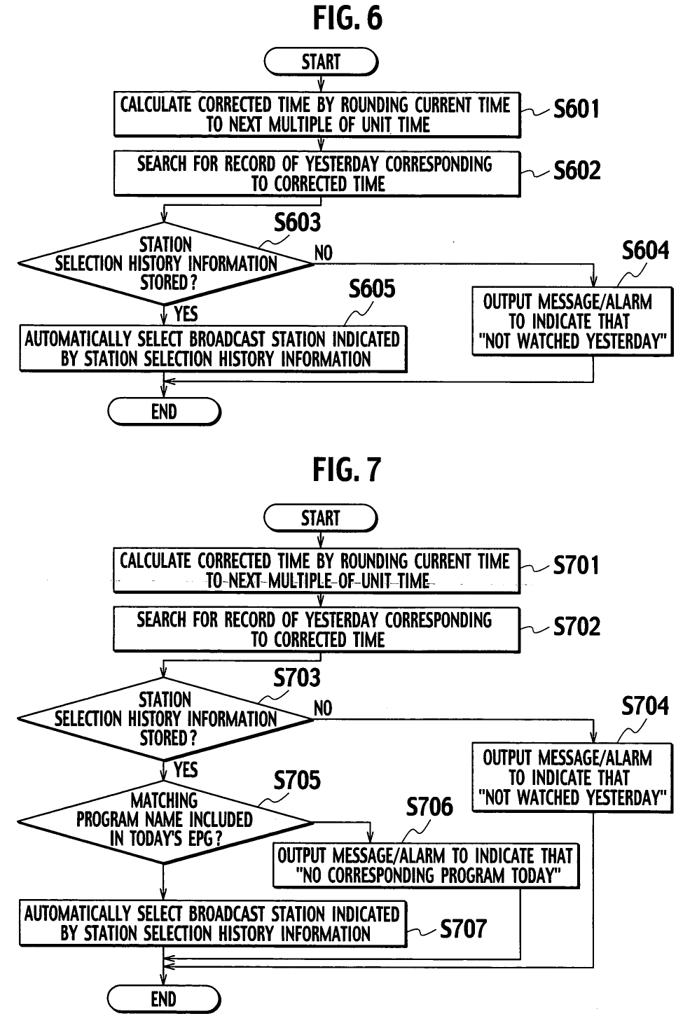

Next, with reference to the flowchart in FIG. 6, the following describes an example of the algorithm for auto-tuning in to the channel of the same program watched in the past, for example, a predetermined number of days ago. In the example below, it is assumed that “a predetermined number of days ago” is “a day ago (that is, yesterday)” and that the user wants to auto-tune in to the channel of the program watched at the same time of day. This algorithm is applicable also to the automatic tuning in to the channel of the program watched at the same time of day of “a week ago (that is, last week)”. Of course, a predetermined past period, for example, within a week, within two weeks, or within a month, can also be specified.

First, the user presses the Yesterday key 103 on the remote controller 101 or the Yesterday button 115 on the GUI screen to instruct the automatic tuning in to the broadcast station of the program watched yesterday. In response to this instruction, the processing shown in FIG. 6 is started.

Next, the CPU 208 calculates a “corrected time” by rounding the current time, stored in the RTC 215, to the next multiple of the unit time (unit times used when a station selection history information record is recorded in the flash memory 211) (step S601). For example, if the unit time is 5 minutes and the current time is between 20:55 (00 second) and 20:59 (59 seconds) on Thursday, the corrected time is calculated as 21:00 on Thursday and, if the current time is between 3:00 (00 second) and 3:04 (59 seconds) on Monday, the corrected time is calculated as 3:05 on Monday. Similarly, if the current time is between 23:55 (00 second) and 23:59 (59 seconds) on Sunday, the corrected time is calculated as 00:00 on Monday.

Other rounding method that is to round 23:55 (01 second) to 0:00 (00 second) to 0:00 is also applicable.

Next, the CPU 208 searches the flash memory 211 to check if a record of yesterday at the time corresponding to the calculated corrected time is recorded in the flash memory 211 as the station selection history information (step S602). More specifically, the CPU 208 calculates the recording position of a record of yesterday corresponding to the corrected time using expression (2) given above and references the contents of the record at the calculated recording position. For example, if the corrected time is 21:00 on Sunday, the CPU 208 calculates the recording position of a record of yesterday at the time corresponding to the corrected time, that is, the recording position S of the record at 21:00 on Saturday, as shown in expression (3).
S=A+(6×24×60+21×60+0)/5×N=A+1980N (3)

Next, the CPU 208 checks if the record stored at the recording position S calculated by expression (3) contains station selection history information on yesterday (step S603). If this checking indicates that station selection history information on yesterday is not recorded in the record stored at the recording position S, the CPU 208 outputs a message or sounds an alarm to notify the user that “the program was not watched yesterday” and continues tuning into the broadcast station (channel) to which it has been tuned in (step S604).

Conversely, if station selection history information on yesterday is recorded in the record stored at the recording position S, the CPU 208 extracts data on the broadcast station (channel) from the station selection history information, automatically tunes in to the broadcast station (channel) (step S605), and terminates the processing.

Thus, in the first embodiment, if the flash memory 211 stores the station selection history information on the corrected time in a day in the past, for example, a predetermined number of days ago (a day ago, a week ago, etc.) wherein the corrected time is generated by rounding the current time to the next multiple of 5 minutes, 10 minutes and so on, the receiver auto-tunes in to the channel of the program recorded in the station selection history information. Therefore, even if the current time is before the broadcast start time of a desired program, the user can auto-tune into the channel of the desired program.

In addition, because station selection history information recorded in the flash memory 211 need not be stored in a short cycle, for example, at intervals of one minute, but may be stored in a relatively long cycle (in a unit time cycle), for example, at intervals of 5 minutes, 10 minutes, 15 minutes, and so on, the amount of the flash memory 211 can be saved.

In the first embodiment, each of the records shown in FIG. 5 is only required to contain at least data on a broadcast station (channel) as the station selection history information.

Although the unit time used to round the current time is 5 minutes in the example shown in the first embodiment, the unit time is not limited to 5 minutes in the present invention. Instead, the user may change the unit time to 3 minutes, 10 minutes, and so on, as necessary, according to his or her watching status. It is also possible that time zones or days of week, for which different unit times (for example, in 3-minute or 5-minute units) are used, may be mixed. For example, the unit time may be changed according to the time zone in such a way that the current time is rounded to the next multiple of 5 minutes in the evening 17:00-21:00, and to the next multiple of 10 minutes in other time zones. The unit time may also be changed according to the day of week in such a way that the current time is rounded to the next multiple of 5 minutes on Saturday and Sunday, and to the next multiple of 10 minutes on other days of week. Furthermore, the unit time may also be changed by specifying a particular day of week and a particular time zone in such a way that the current time is rounded to the next multiple of 3 minutes only in the evening 17:00-21:00 on Saturday and Sunday, and in unit of 10 minutes on other days of week. Recently, though some programs start at an exact hour such as 19:00 or 21:00, other programs start at an intermediate time such as 18:55, 21:15, or 21:45. Therefore, it is of course possible that the time generated by rounding the current time to the next multiple of the unit time is not only an exact hour such as 19:00 but also an intermediate time such as 18:55, 21:15, or 21:45. It is of course possible that a variable-length unit time may be set in advance so that the resulting rounded-up time is 5 minutes, 10 minutes, 25 minutes, 35 minutes, 50 minutes, or 55 minutes past each hour. This applies also to other embodiments that will be described below.

### Second Embodiment

Next, with reference to the flowchart in FIG. 7, the following describes a second embodiment of the present invention, that is, an example of an algorithm for auto-tuning in to the channel of the same program watched yesterday using an Electronic Program Guide. Note that the processing in step S701 to step S704 in the flowchart shown in FIG. 7 is the same as the processing in step S601 to step S604 in the flowchart shown in FIG. 6. So please refer to descriptions of step S601 to step S604 for step S701 to step S704. Only the different part for step S703 is described below.

If it is found, as a result of checking in step S703, that station selection history information on yesterday is recorded, the CPU 208 extracts data on the broadcast station (channel) and the program name from the station selection history information. Next, the CPU 208 checks if program information, composed of the same channel and the same program name as those extracted from the station selection history information, is included in the Electronic Program Guide as the program information corresponding to the corrected time of today (step S705). The Electronic Program Guide is created by obtaining SI information that is actually broadcast or program information on Internet programs that are currently broadcast. The CPU 208 extracts the program information such as the channel or the name of the currently broadcast program from the Electronic Program Guide and compares the extracted information with the station selection history information. For example, if the corrected time calculated in step S701 is 7:45 on Friday and if the station selection history information corresponding to 7:45 on Thursday, the previous day, is composed of the broadcast station (channel) “channel 011 of digital terrestrial broadcast” and the program name “Morning News”, the CPU 208 checks if the name of the program included in the Electronic Program Guide as a program that is broadcast at 7:45 today is “Morning News” on “channel 011 of digital terrestrial broadcast”.

If it is found, as the result of checking, that the Electronic Program Guide includes a program with the matching channel and the matching program name at the corrected time of today, the receiver auto-tunes in to the broadcast station (channel) extracted from the station selection history information (step S707) and the processing is terminated.

Conversely, if the Electronic Program Guide does not include a program with the matching channel and the matching program name at the corrected time of today, the CPU 208 outputs a message or sounds an alarm to notify the user that “there is no corresponding program today” and continues tuning in to the broadcast station (channel) to which it has been tuned in (step S706).

In this case, a part of a program name may be compared. For example, there is a program name such as “Drama XXXX (3)”. In such a case, because the program name of last week is “Drama XXXX (2)”, the program names do not completely match. If the serial number is removed, they are determined to be the same program.

As described above, the second embodiment is similar to the first embodiment in that, if the station selection history information on a past time corresponding to the corrected time, generated by rounding the current time to the next multiple of the unit time such as 5 minutes or 10 minutes, is recorded in the flash memory 211, for example, if the station selection history information at the current time of a predetermined number of days ago (a day ago, a week ago, etc.) is recorded in the flash memory 211, the receiver auto-tunes in to the channel of the program recorded in the station selection history information. Therefore, even if the current time is before the broadcast start time of a desired program, the user can tune in to the channel of the desired program.

As in the first embodiment described above, because the station selection history information recorded in the flash memory 211 need not be stored in a short cycle, for example, at intervals of one minute, but may be stored in a relatively long cycle (in a unit time cycle), for example, at intervals of 5 minutes, 10 minutes, 15 minutes, and so on, the amount of the flash memory 211 can be saved.

In the second embodiment, if it is found, as the result of checking in step S703, that the station selection history information on yesterday is stored, the broadcast station (channel) and the program name are extracted from the station selection history information and a check is made whether or not the program information composed of the same channel and the same program name as those extracted from the station selection history information is included in the Electronic Program Guide as the program information at the corrected time of today. If the Electronic Program Guide includes a program with the same channel and with the same program name, the receiver auto-tunes in to the channel. Therefore, when a desired program is not broadcast because the program broadcast schedule is changed due to the broadcast of a special program, the auto-tune function is disabled to prevent an incorrect station from being selected.

### Third Embodiment

Next, the following describes a third embodiment of the present invention.

In the first and second embodiments described above, when the user watches programs while zapping the channels to switch among a plurality of channels in a short time, the history information is changed every unit time, for example, every 5 minutes, and the user sometimes tunes in to an unintended program.

Another problem is that, when the selection of a program is delayed from the program start time in some week even for one minute, the user cannot watch the program from the start in the next week. For example, assume that the user who wants to watch a program that starts at 21:00 on channel 1 switches the channel at 21:01, that is, one minute later, from channel 3 to channel 1 and watches the program for one hour on channel 1; in this case, if the user presses the Confirmation key for the “watch same program watched last week button” 113 at 20:58 next week, channel 3 is unintentionally selected instead of channel 1 that is a desired channel.

In the third embodiment, as well as in a fourth embodiment that will be described next, a receiving device is designed so that the user can correctly select an intended station even if the user zaps multiple channels in a short time for watching programs.

In this embodiment, the watching history information indicating which broadcast station the user watches in each unit time is stored and, based on this information, the station is selected automatically. The following describes the processing in detail.

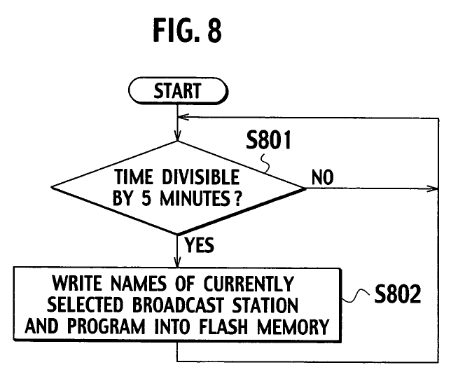

FIG. 8 shows an example of the procedure for registering watching history information in the flash memory 211. FIG. 8 is the same as FIG. 4 except that the unit time is assumed to be 5 minutes.

As shown in the figure, when the receiving device start receiving a broadcast, the processing is started. The CPU 208 waits until the current time (in minutes) stored in the RTC 215 reaches a time divisible by 5 minutes that is the same unit time used in the first and second embodiments (step S801: NO). This time refers to exactly 0 minute, 5 minutes, 10 minutes, 15 minutes, . . . , or 55 minutes of each hour. When the current time reaches a time divisible by 5 minutes (step S801: YES), the CPU 208 writes the names of the currently selected broadcast station and the program name into the flash memory 211 (step S802).

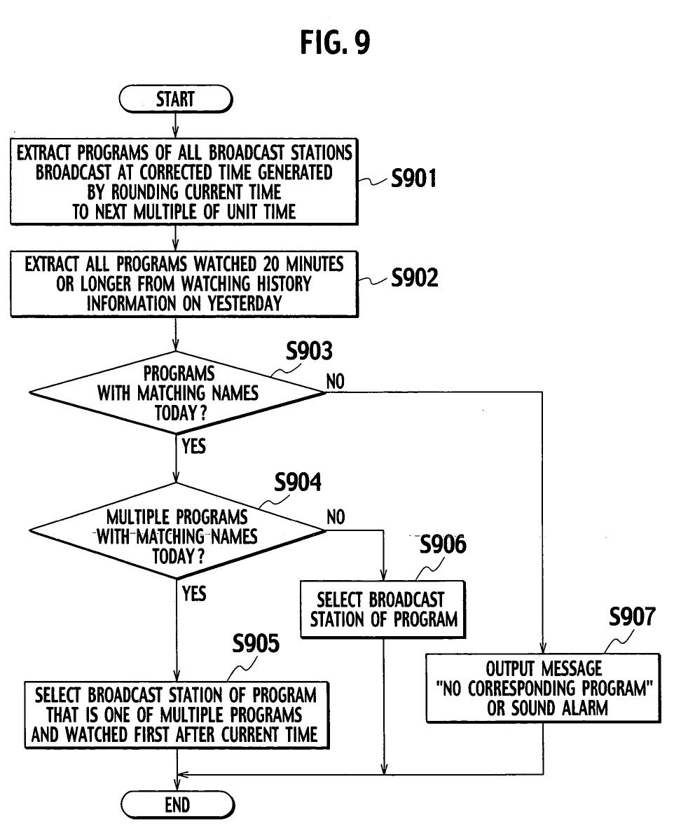

Next, with reference to the flowchart in FIG. 9, the following describes how to tune in to the broadcast station of the program, which was watched yesterday, using the watching history information described above. Although the following describes how to tune in to the broadcast station of the program that was watched yesterday, the description given below is applicable also to how to tune in to the broadcast station of the program watched last week.

First, when the user presses the Yesterday key 103 of the remote controller in FIG. 2 or the Yesterday button 115 in FIG. 3 and an instruction to select the broadcast station of the program watched yesterday is received, the processing is started.

Next, the time is corrected based on the unit time described above. For example, when the unit time is 5 minutes and the current time is 20:56-20:59 on Thursday, the time is corrected to 21:00 on Thursday. When the time is 3:00-3:04 on Monday, the time is corrected to 3:05 on Monday. When the time is 23:56-23:59 on Sunday, the time is corrected to 0:00 on Monday. In the description below, the time corrected as described above is used. All programs broadcast at the corrected time are extracted from the Electronic Program Guide stored in the flash memory 211 at that time (step S901).

Next, all programs watched for a predetermined time (for example, 20 minutes) or longer are extracted from the watching history information on yesterday (step S902). Instead of all programs watched yesterday, the programs watched in the range 3 hours before and after the current time or one hour before and two hours after the current time may also be extracted. The user may set the predetermined watching time of 20 minutes to any length of time, for example, 10 minutes, 15 minutes, 30 minutes, 40 minutes, and so on.

Next, whether there are matching programs included both in the programs obtained in step S901 and in the programs obtained in step S902 is checked (step S903).

If there is no such program (step S903: NO), a message indicating that “No corresponding program today” is displayed or an alarm is sounded to alert the user (S907).

On the other hand, if there are such matching programs (step S903: YES), whether there are two or more such programs is checked (step S904).

If there is only one such program (step S904: NO), the receiver tunes in to the broadcast station that broadcast that only one program (step S906).

On the other hand, if there are two more corresponding programs (step S904: YES), the receiver tunes in to the broadcast station of the program watched first after the current time (S905). Although the receiver tunes in to the broadcast station of the program watched first after the current time in this example, it is of course possible for the receiver to tune in to the broadcast station of the program watched first after the corrected time generated by rounding the current time to the next multiple of the unit time.

After the operation in step S901-step S907 is completed, all the processing is terminated.

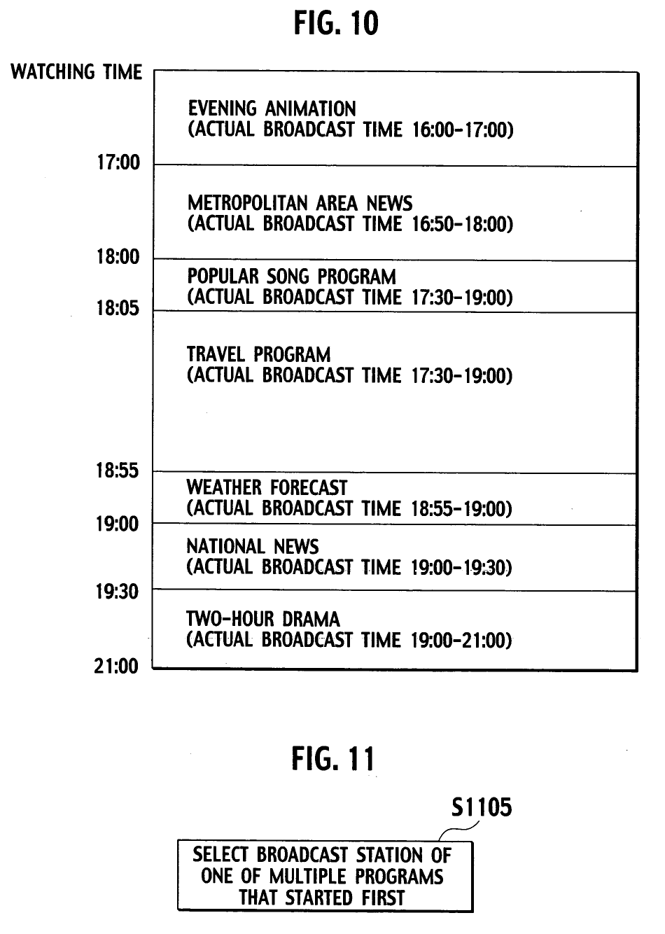

Next, the following describes the detail of the watching history described above with reference to FIG. 10. Note that, in the figure, the watching time refers to an actual watching time in increments of the unit time (for example, 5 minutes) included in the watching history described above and the actual broadcast time is the start time and the end time of a program.

More specifically, the user watched “Evening Animation” for 16:00-17:00 that is the same as the actual broadcast time, as shown in FIG. 10.

The actual broadcast time of “Metropolitan Area News” is 16:50-18:00, and the user actually watched the program yesterday for 17:00-18:00.

The actual broadcast time of “Popular Song Program” is 17:30-19:00, and the user actually watched the program yesterday for 18:00-18.05.

The actual broadcast time of “Travel Program” is 17:30-19:00, and the user actually watched the program yesterday for 18:05-18:55.

The user watched “Weather Forecast” for 18:55-19:00 that is the same as the actual broadcast time.

The user watched “National News” for 19:00-19:30 that is the same as the actual broadcast time.

The actual broadcast time of “Two-Hour Drama” is 19:00-21:00, and the user actually watched the program yesterday for 19:30-21:00.

That is, this watching history indicates the following. Although the actual broadcast time of Popular Song Program is 17:30-19:00, the user watched the program for 18:00-18:05. After the broadcast of Popular Song Program was started, the user switched the channel to Travel Program. The user watched National News for 19:00-19:30 and, after that, watched Two-Hour Drama. That is, though the actual broadcast time of Two-Hour Drama described above is 19:00-21:00, the user gave priority to National News at first and did not watch the first 30 minutes of Two-Hour Drama. Because the unit time is 5 minutes in this example, the watching time in the record in the watching history is 18:05-18:50 even if the actual watching time is 18:01-18:52.

Next, the following describes the operation performed when the Yesterday key 103 (see FIG. 2) or the Yesterday button 115 (see FIG. 3) is pressed to watch the program that was watched yesterday at a time given below. It is assumed that the unit time used to round the current time is 5 minutes and that the predetermined watching time used to eliminate zapped programs is 20 minutes.

In a first example, assume that the Yesterday key 103 or the Yesterday button 115 is pressed at 16:53. Because the corrected time is 16:55, the programs of all broadcast stations broadcast at the corrected time 16:55 are selected as in step S901 in FIG. 9. Assume that Evening Animation is not broadcast today and that Metropolitan Area News is broadcast from 16:50 to 18:00 as usual. Because Metropolitan Area News was watched for longer than 20 minutes yesterday, the program is recognized as a program with the matching name in step S903 in FIG. 9 and is recognized as the only one matching program in step S904. Therefore, control is passed to step S906 and the broadcast station (channel) that broadcast Metropolitan Area News is selected.

In a second example, assume that the Yesterday key 103 or the Yesterday button 115 is pressed at 17:52. The corrected time becomes 17:55. Assume that all programs, that is, Metropolitan Area News, Popular Song Program, and Travel Program, are broadcast at 17:55 today as scheduled. However, Popular Song Program, which was not watched yesterday for longer than the predetermined watching time (20 minutes), is eliminated from the candidates in step S902 in FIG. 9. Metropolitan Area News and Travel Program are recognized as candidates in step S903 and the fact that there are multiple candidates is recognized in step S904. Therefore, control is passed to step S905. Because Metropolitan Area News was watched from 17:00 to 18:00 and Travel Program was watched from 18:05 to 18:55, Metropolitan Area News that was watched first is selected. If neither Metropolitan Area News nor Travel Program is broadcast, the message indicating that there is no corresponding program is displayed in step S907.

In a third example, assume that the Yesterday key 103 or the Yesterday button 115 is pressed at 18:58. Also assume that both National News and Two-Hour Drama are broadcast from 19:00 today as scheduled. The corrected time is 19:00, and both National News and Two-Hour Drama were watched for longer than the predetermined watching time (20 minutes) yesterday. Therefore, it is found in step S904 in FIG. 9 that there are multiple matching programs. In this case, control is passed to step S905 and, because National News was watched from 19:00 to 19:30 and Two-Hour Drama was watched from 19:30 to 21:00, the broadcast station of National News that was watched first is selected.

If National News is broadcast today but Two-Hour Drama is not broadcast today, then National News is determined to be the only matching program in step S904. Control is passed to step S906 and the broadcast station that broadcasts National News is selected.

In contrast, if National News is not broadcast today but Two-Hour Drama is broadcast today, then Two-Hour Drama is determined to be the only matching program in step S904. Control is passed to step S906 and the broadcast station that broadcasts Two-Hour Drama is selected.

In a fourth example, assume that the Yesterday key 103 or the Yesterday button 115 is pressed at 17:57. In this case, the current time is recognized as 18:00 in the time correction processing in step S901. Therefore, even if all programs, that is, Metropolitan Area News, Popular Song Program, and Travel Program, are broadcast today, Metropolitan Area News that ends at 18:00 is eliminated first from the candidates in step S901 in FIG. 9. Next, Popular Song Program, which was not watched for longer than 20 minutes, is eliminated from the candidates in step S902. Travel Program is recognized as the candidate in step S903, and the fact that there is no multiple candidates is recognized in step S904. Control is then passed to step S906 and Travel program is selected.

Thus, in the third embodiment, a program that is broadcast at the corrected time, generated by rounding the current time to the next multiple of the unit time, is used as a candidate for auto-tuning, as in the first and the second embodiments. Therefore, if the Yesterday key 103 or the Yesterday button 115 is pressed during the broadcasting of a program or if the user started watching a program yesterday after the start of the program, the user can tune in to an intended broadcast station in this embodiment. For example, even if the program was switched from Popular Song Program to Metropolitan Area News at 18:10 yesterday, the same operation is performed in the fourth example.

For the receiving device in the first and second embodiments, the watching history information on the programs is changed every unit time (for example, 5 minutes) when the user watches programs while zapping multiple cannels in a short time, sometimes with the result that the receiver tunes in to an unintended program. In contrast, for the receiving device in the third embodiment, the programs of all broadcast stations broadcast at corrected time, generated by rounding the current time, are compared with those in the watching history information on a past time, such as yesterday and last week, that were watched for longer than a predetermined time (for example, 20 minutes). If there are multiple matching programs, the broadcast station that broadcast the program that was watched first after the current time is selected. This method eliminates zapped programs, watched only for a time shorter than the predetermined watching time, and thus prevents a program not intended by the user from being selected.

More specifically, in the first and second embodiments described above, when the selection of a program is delayed from the program start time in some week even for one minute, the user sometimes cannot watch the program from the start in the next week. For example, assume that the user who wants to watch a program that starts at 21:00 on channel 1 switches the channel at 21:01, that is, one minute later, from channel 3 to channel 1 and, after that, watches the program for one hour on channel 1; in this case, if the user presses the Confirmation key for the “watch same program watched last week button” 113 at 20:58 next week, channel 3 is unintentionally selected instead of channel 1 that is a desired channel. However, in the third embodiment, if the watching time of channel 3 selected at 21:01 is shorter than a predetermined watching time because it is simply zapped, channel 3 is eliminated from the candidates even if it was selected at the corrected time for watching in a past such as yesterday or last week. Therefore, channel 1 intended by the user is selected if it satisfies the condition shown in step S905.

### Fourth Embodiment

Next, the following describes a fourth embodiment. In this embodiment, step S1105 in FIG. 11 is executed instead of the operation of step S905 in FIG. 9 in the third embodiment described above.

That is, when the processing is started in the fourth embodiment, the time is corrected based on the unit time and all programs broadcast at the corrected time are extracted from the Electronic Program Guide stored in the flash memory 211 at the corrected time (step S901) as in the third embodiment shown in FIG. 9. Next, all programs watched longer than a predetermined time (for example, 20 minutes) are extracted from the watching history information on yesterday (step S902). In this case, instead of all programs, the programs in the range 3 hours before and after the current time or those watched one hour before and two hours after the current time may also be extracted.

Next, whether there are matching programs included both in the programs obtained in step S901 and in the programs obtained in step S902 is checked (step S903). If there is no such program (step S903: NO), the processing in step S907 is performed as in the third embodiment. If there are such programs (step S903: YES) but if there is only one such program (step S904: NO), the processing in step S906 is performed as in the third embodiment described above.

On the other hand, if there are matching programs (step S903: YES) and if there are multiple such programs (step S904: YES), the processing different from that in the third embodiment is performed. In the fourth embodiment, the processing shown in FIG. 11 is performed, that is, the receiver tunes in to the broadcast station of one of multiple programs that started first (step S1105).

For the receiving device in the first and second embodiments, the history information is changed every unit time (for example, 5 minutes) when the user watches programs while zapping multiple cannels in a short time, sometimes with the result that the receiver tunes in to an unintended program. In contrast, for the receiving device in the fourth embodiment, the programs of all broadcast stations broadcast at the corrected time, generated by rounding the current time, are compared with those in the watching history information on yesterday or last week that were watched for longer than a predetermined time (for example, 20 minutes). If there are multiple matching programs, the broadcast station that broadcast one of those programs that was started first is selected. Therefore, as in the third embodiment described above, this method eliminates zapped programs watched only for a time shorter than the predetermined watching time and thus prevents a program, which is not intended by the user, from being selected.

The processing of step S905 shown in FIG. 9 may be replaced with various conditions other than that of step S1105 described above.

For example, the processing of step S1105 described above may be configured in such a way that the receiver tunes in to the broadcast station of one of multiple programs that has the remaining broadcast time of 15 minutes or longer from the current time and that was watched first. Even if there are multiple programs with matching names today as a result of checking in step S904, this configuration eliminates a program, whose remaining broadcast time from the current time is shorter than 15 minutes, from the candidates, thus making it possible to automatically select a program that suits user's past watching preference and that satisfies the current broadcast condition.

Similarly, the processing in step S1105 described above may be configured in such a way that the receiver tunes in to the broadcast station of one of multiple programs whose remaining broadcast time from the current time is longer than the half of the total broadcast time and which was watched first. Even if there are multiple programs with matching names today as a result of checking in step S904, this configuration eliminates a program, whose remaining broadcast time from the current time is shorter than the half of the total broadcast time, from the candidates, thus making it possible to automatically select a program that suits user's past watching preference and that satisfies the current broadcast condition.

Similarly, the processing in step S1105 described above may be configured in such a way that the receiver tunes in to one of multiple programs whose watching time was longest. Even if there are multiple programs with matching names today as a result of checking in step S904, this configuration selects the program whose watching time was longest in the past such as yesterday or last week, thus making it possible to automatically select a program that suits user's past preference.

In addition, the processing may be configured so that the user can switch those conditions via a menu.

It should be understood that many modifications and adaptations of the invention will become apparent to those skilled in the art and it is intended to encompass such obvious modifications and changes in the scope of the claims appended hereto.

What is claimed is:

1. A receiving device comprising:
receiving means for receiving a broadcast;
operation means for performing a station selection instruction operation;
storage means for sequentially storing station selection history information including at least a selected broadcast station for each unit time; and
control means for, when station selection history information in a past at a time corresponding to a corrected time is stored in said storage means, selecting a broadcast station included in the stored station selection history information, said corrected time being generated by rounding a current time to a next multiple of the unit time.

2. The receiving device according to claim 1, further comprising acquisition means for acquiring an Electronic Program Guide that includes broadcast stations, program start/end dates and times, and program names of programs that are broadcast,
wherein, if the station selection history information in a past at a time corresponding to a corrected time is stored in said storage means, said control means further checks if program information, composed of the same broadcast station and the same program name as a broadcast station and a program name stored in the station selection history information, is included in the Electronic Program Guide as program information at the corrected time of today and, if such program information is included, selects the broadcast station stored in the stored station selection history information.

3. A receiving station comprising:
receiving means for receiving a broadcast;
acquisition means for acquiring an Electronic Program Guide that includes broadcast stations, program start/end dates and times, and program names of programs that are broadcast;
operation means for performing a station selection instruction operation;
storage means for sequentially storing watching history information including at least a selected broadcast station, a program name, a watching start date and time, and a watching time for each unit time; and
control means that acquires program information on all broadcast stations broadcast at a time corresponding to a corrected time, generated by rounding a current time to a next multiple of the unit time, from the Electronic Program Guide and at the same time extracts programs, watched for a time equal to or longer than a predetermined watching time, from station selection history information in a past stored in said storage means, compares the program information on all broadcast stations broadcast at the time corresponding to the corrected time with the programs watched for a time equal to or longer than the predetermined watching time, and, if there is one matching program, selects a broadcast station of the matching program and, if there are a plurality of matching programs, selects a broadcast station of one program from the plurality of matching programs.

4. The receiving device according to claim 3
wherein, if there are the plurality of matching programs as a result of the comparison between the program information on all broadcast stations broadcast at a time corresponding to the corrected time and the programs watched for a time equal or longer than the predetermined watching time, said control means selects a broadcast station of a program watched first after the current time from the plurality of matching programs.

5. The receiving device according to claim 3
wherein, if there are the plurality of matching programs as a result of the comparison between the program information on all broadcast stations broadcast at a time corresponding to the corrected time and the programs watched for a time equal or longer than the predetermined watching time, said control means selects a broadcast station of a program started first from the plurality of matching programs.

6. The receiving device according to claim 3
wherein, if there are the plurality of matching programs as a result of the comparison between the program information on all broadcast stations broadcast at a time corresponding to the corrected time and the programs watched for a time equal or longer than the predetermined watching time, said control means selects a broadcast station of a program watched for a longest time from the plurality of matching programs.

7. A receiving method comprising the steps of:
sequentially storing station selection history information including at least a selected broadcast station for each unit time;
calculating a corrected time in response to an automatic station selection instruction from a user, said corrected time being generated by rounding a current time to a next multiple of the unit time; and
checking if the station selection history information in a past at a time corresponding to the corrected time is stored and, if such information is stored, selecting a broadcast station included in the stored station selection history information.
